(19) United States
(12) Patent Application Publication
(10) Pub. No.: US 2005/0289251 A1
(43) Pub. Date: Dec. 29, 2005

(54) Single chip device, and method and system for testing the same

(76) Inventors: Chin-Chou Lee, Hsinchu Hsien (TW); Chun-Huang Lin, Hsinchu Hsien (TW)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/971,101

(22) Filed: Oct. 25, 2004

(30) Foreign Application Priority Data
Jun. 29, 2004 (TW) 93118925

(51) Int. Cl. G06F 13/10

(52) U.S. Cl. 710/14

(57) ABSTRACT

A single chip device includes a first transmission interface connected to an external testing device, a second transmission interface connected to the testing device, and a processor unit coupled to the first and second transmission interfaces and operable in one of a normal operating mode, where data transmission between the single chip device and the testing device is performed at a first transmission rate via the first transmission interface, and a testing mode, where data transmission between the single chip device and the testing device is performed at a second transmission rate different from the first transmission rate via the second transmission interface. A method and system for testing the single chip device are also disclosed.

### CROSS-REFERENCE TO RELATED APPLICATION

This application claims priority of Taiwanese Application No. 093118925, filed on Jun. 29, 2004.

### BACKGROUND OF THE INVENTION

1. Field of the Invention

The invention relates to a single chip device, more particularly to a single chip device, and method and system for testing the same.

2. Description of the Related Art

Image sensors, such as CMOS devices, have been widely applied to optical mouses, digital cameras, image telephones and mobile phones.

FIGS. 1 and 2 illustrate a conventional optical mouse which includes a base plate 91, a light-guiding module 92 mounted on the base plate 91, a circuit board 93 disposed on the base plate 91, and a light-emitting element 94 and an image sensor 95 mounted on the circuit board 93. The base plate 91 is formed with a slot 911. The light-guiding module 92 is formed with a through hole 922. The image sensor 95 includes an image sensing device (not shown) in the form of a single chip device. Light emitted by the light-emitting element 94 is guided by the light-guiding module 92 to pass through the slot 911 in the base plate 91. Subsequently, the guided light is reflected by an operating plane 96 and passes through the through hole 922 in the light-guiding module 92 and toward the image sensor 95 such that the image sensor 95 generates an electrical signal associated with the light received thereby.

For testing the conventional optical mouse, the conventional optical mouse is set to operate in one of a USB HID transmission mode and a PS/2 transmission mode depending on the desired interface connection. However, the USB HID transmission mode and the PS/2 transmission mode are suitable for data transmission performed by low speed devices, such as mouses or keyboards. Therefore, the USB HID transmission mode and the PS/2 transmission mode are unsuitable for mass image data transmission.

### SUMMARY OF THE INVENTION

Therefore, the object of the present invention is to provide a single chip device, and method and system for testing the same that can perform testing operation at a higher speed.

According to one aspect of the present invention, a single chip device comprises:
a first transmission interface adapted to be connected to an external testing device;
a second transmission interface adapted to be connected to the testing device; and
a processor unit coupled to the first and second transmission interfaces and operable in one of a normal operating mode, where data transmission between the single chip device and the testing device is performed at a first transmission rate via the first transmission interface, and a testing mode, where data transmission between the single chip device and the testing device is performed at a second transmission rate different from the first transmission rate via the second transmission interface.

According to another aspect of the present invention, there is provided a testing system for testing a single chip device. The testing system comprises:
a testing device including first and second connecting ports adapted to be connected to the single chip device, the testing device being adapted to enable the single chip device to operate in a desired one of a normal operating mode, where data transmission is performed at a first transmission rate via the first connecting port, and a testing mode, where data transmission is performed at a second transmission rate via the second connecting port, the first and second connecting ports being configured to transmit data at different transmission rates.

According to a further aspect of the present invention, there is provided a method for enabling implementation of speedy testing of a single chip device that is coupled to a testing device and that is operable in a normal operating mode, where data transmission is performed at a first transmission rate. The method comprises the steps of:
a) configuring the single chip device to be further operable in a testing mode, where data transmission from the single chip device to the testing device is performed at a second transmission rate different from the first transmission rate;
b) enabling the single chip device to operate in the testing mode; and
c) testing data transmitted from the single chip device at the second transmission rate.

According to still another aspect of the present invention, a single chip device comprises:
an image sensor for generating raw image data;
a processing unit coupled to the image sensor to process the raw image data; and
a transmission interface unit coupled to the processing unit;
the transmission interface unit being operable so as to selectively transmit image data processed by the processing unit by a first transmission protocol, and either of the raw image data or the image data by a second transmission protocol at a transmission rate different from that of the first transmission protocol to an external testing device.

According to still another aspect of the present invention, there is provided a method of testing a single chip device that includes a data acquisition module, a processing unit coupled to the data acquisition module, and a transmission interface unit coupled to the processing unit. The method comprises the steps of:
enabling the data acquisition module to generate raw data;
enabling the processing unit to process the raw data; and
selectively transmitting data processed by the processing unit by a first transmission protocol, and either of the raw data or the data by a second transmission protocol at a transmission rate different from that of the first transmission protocol via the transmission interface unit to an external testing device.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional optical mouse;

FIG. 2 is a schematic sectional view showing the conventional optical mouse;

FIG. 3 is a schematic circuit block diagram illustrating the first preferred embodiment of a testing system for testing a single chip device according to this invention;

FIG. 4 is a schematic circuit block diagram illustrating another single chip device tested by the first preferred embodiment;

FIG. 5 is a schematic circuit block diagram illustrating the second preferred embodiment of a testing system for testing a single chip device;

FIG. 6 is a flow chart illustrating an operation procedure of the second preferred embodiment;

FIG. 7 is a schematic circuit block diagram illustrating the third preferred embodiment of a testing system for testing a single chip device;

FIGS. 8a and 8b are graphs of clock and data signals transmitted between the first preferred embodiment and the single chip device of FIG. 4 when the single chip device is operable in a normal operating mode; and

FIGS. 9a and 9b are graphs of clock and data signals transmitted between the first preferred embodiment and the single chip device of FIG. 4 when the single chip device is operable in a testing mode.

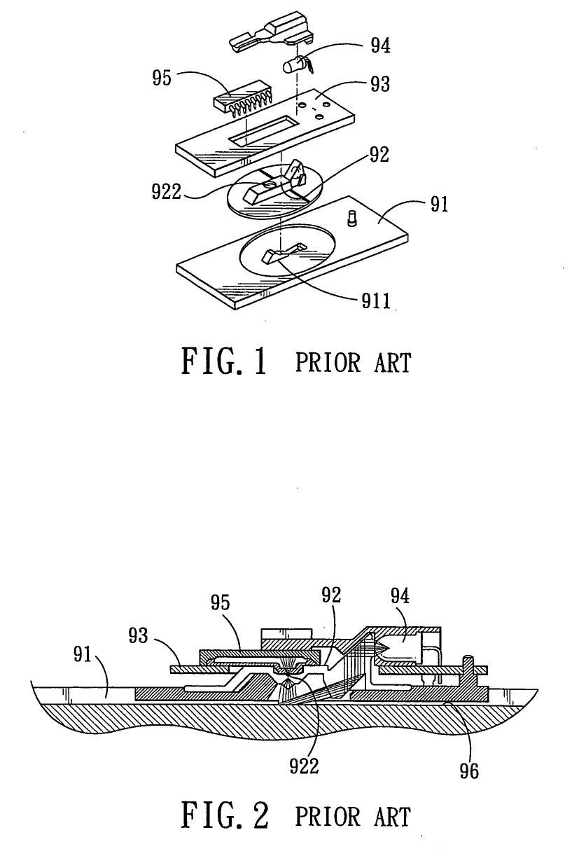

### DETAILED DESCRIPTION OF THE PREFERRED EMBODIMENTS

Before the present invention is described in greater detail, it should be noted that like elements are denoted by the same reference numerals throughout the disclosure.

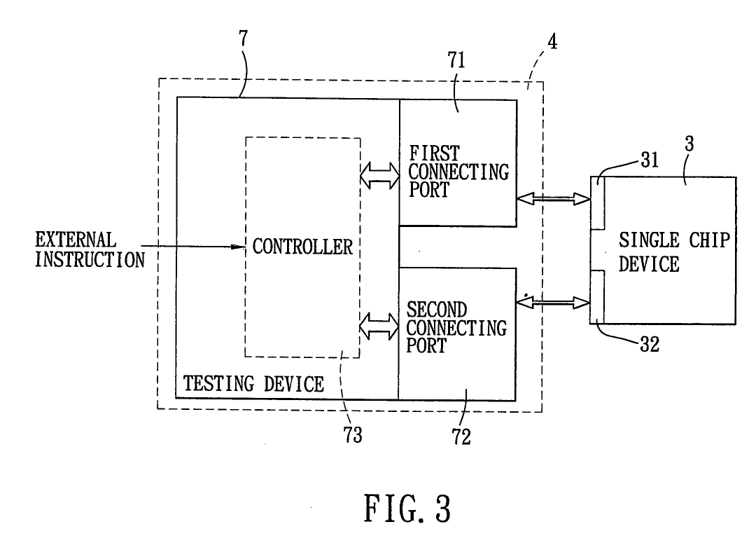

Referring to FIG. 3, the first preferred embodiment of a testing system 4 for testing a single chip device 3 according to the present invention is shown to include a testing device 7. In this embodiment, the single chip device 3 includes a first transmission interface 31 and a second transmission interface 32. The single chip device 3 is operable in one of a normal operating mode, where data transmission between the single ship device 3 and the testing device 7 is performed at a first transmission rate via the first transmission interface 31, and a testing mode, where data transmission between the single chip device 3 and the testing device 7 is performed at a second transmission rate different from the first transmission rate via the second transmission interface 32.

The testing device 7, which is suitable for testing of integrated circuit devices in this embodiment, includes a first connecting port 71, such as PS/2 or USB HID, adapted to be connected to the first transmission interface 31 of the single chip device 3, a second connecting port 72 adapted to connected to the second transmission interface 32 of the single chip device 3, and a controller 73 connected to the first and second connecting ports 71, 72. The controller 73 is operable to enable the single chip device 3 to operate in a desired one of the normal operating mode, where data transmission is performed at the first transmission rate via the first connecting port 71, and the testing mode, where data transmission is performed at the second transmission rate via the second connecting port 72, in response to an external instruction. It is noted that the second transmission rate is greater than the first transmission rate.

In this embodiment, data transmission in the testing mode conforms with a serial interface communications protocol, such as RS232, I²C (Inter-Integrated Circuit) communications protocol proposed in U.S. Pat. No. 4,689,740, or SPI™ (Serial Peripheral Interface) communications protocol proposed in U.S. Pat. No. 4,816,996. Specifically, maximum clock frequencies permitted in RS232, I²C and SPI™ interfaces are 115.2 kHz, 400 kHz and 4 MHz, respectively, which are significantly higher than those in PS/2 and USB HID interfaces (roughly 16.6 kHz).

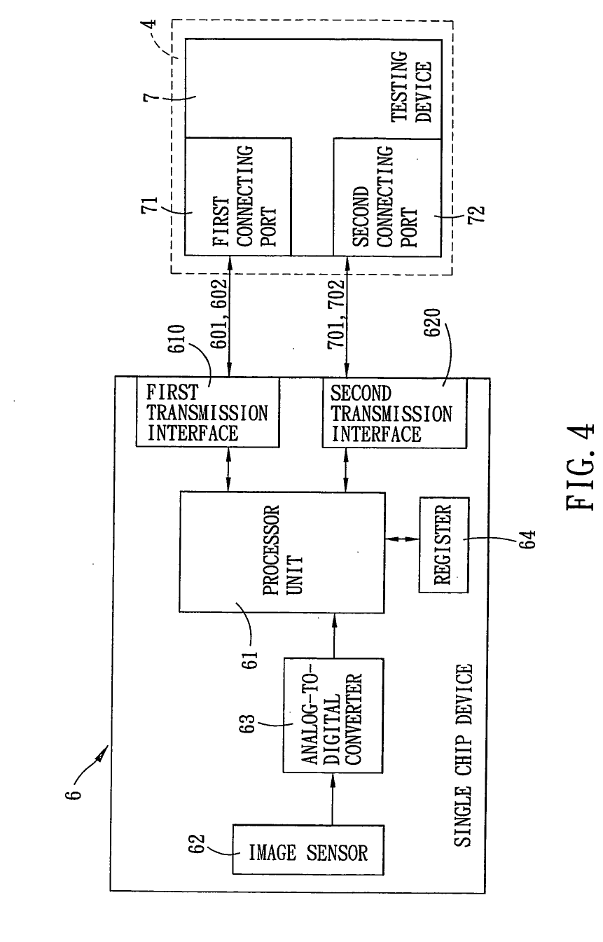

FIG. 4 illustrates another single chip device 6 for an optical mouse tested by the testing system 4 of the first preferred embodiment. The single chip device 6 includes a transmission interface unit that includes a first transmission interface 610 adapted to be connected to the first connecting port 71 of the testing device 7, and a second transmission interface 620 adapted to be connected to the second connecting port 72 of the testing device 7; a processor unit 61 connected to the first and second transmission interfaces 610, 620; and a data acquisition module that includes an image sensor 62, such as a CMOS device, operable so as to generate test data, i.e., raw image data, to be transmitted to the testing device 7, an analog-to-digital converter 63 coupled electrically to the image sensor 62 and the processor unit 61 for converting the test data into digital data, and a register 64 coupled electrically to the processor unit 61 for storing data for the processor unit 61.

The processor unit 61 is operable in one of a normal operating mode, where data transmission between the single chip device 6 and the testing device 7 is performed at a first transmission rate via the first transmission interface 610 and the first connecting port 71 of the testing device 7, and a testing mode, where data transmission between the single chip device 6 and the testing device 7 is performed at a second transmission rate greater than the first transmission rate via the second transmission interface 620 and the second connecting port 72 of the testing device 7.

With this configuration, clock and data signals 601, 602 are transmitted between the testing device 4 and the single chip device 6 via the first connecting port 71 and the first transmission interface 610 when the processor unit 61 is operable in the normal operating mode, while clock and data signals 701, 702 are transmitted between the testing device 4 and the single chip device 6 via the second connecting port 72 and the second transmission interface 620 when the processor unit 61 is operable in the testing mode.

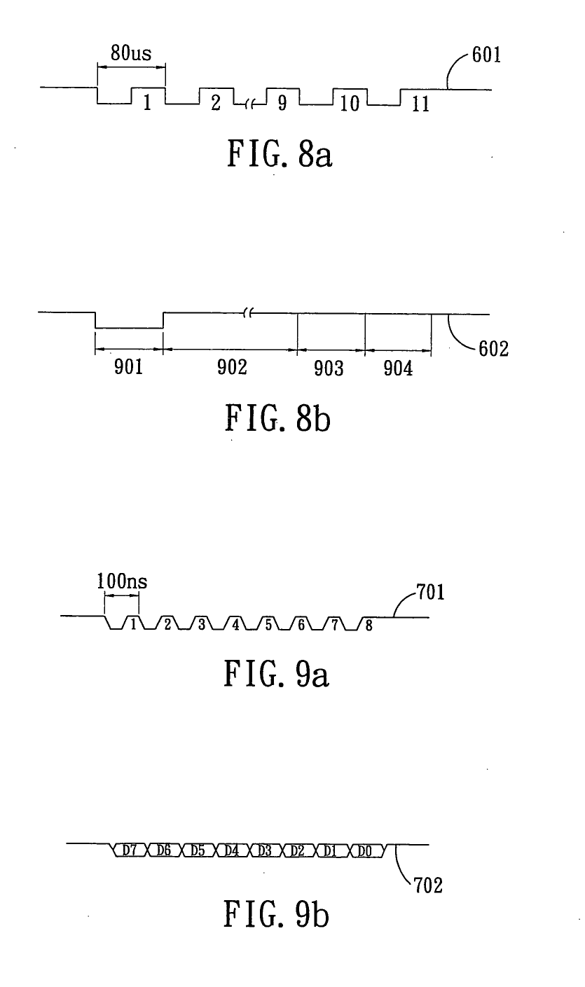

Referring to FIGS. 8a and 8b, there are shown examples of the clock and data signals 601, 602 transmitted in the normal operating mode, such as a PS/2 mode, respectively. In FIG. 8a, each clock cycle of the clock signal 601 is 80 μs. In FIG. 8b, the data signal 602 is composed of one start bit 901, eight data bits 902 (Bit0˜Bit7), one parity bit 903 and one stop bit 904, that is, the data signal 602 has 11 bits. Therefore, transmission of the data signal 602 in the normal operating mode takes 880 μs (80 μs/clock×11 clock cycles). Referring to FIGS. 9a and 9b, there are shown examples of the clock signal 701 and the 1-byte data signal 702 transmitted in the testing mode, respectively. In FIG. 9a, each clock cycle of the clock signal 701 is 100 ns. Therefore, transmission of the one-byte data signal 702 in the testing mode takes 800 ns (100 ns/clock×8 clock cycles), which is significantly shorter than the signal transmission in the normal operating mode. Therefore, it takes 225.28 ms (880 μs×256) to transmit 16×16 pixel array image data (256-byte image data) generated by the CMOS image sensor 62 in the normal operating mode, while, in the testing mode, it takes 204.8 μs (800 ns×256) such that the second transmission rate is 1100 times faster than the first transmission rate.

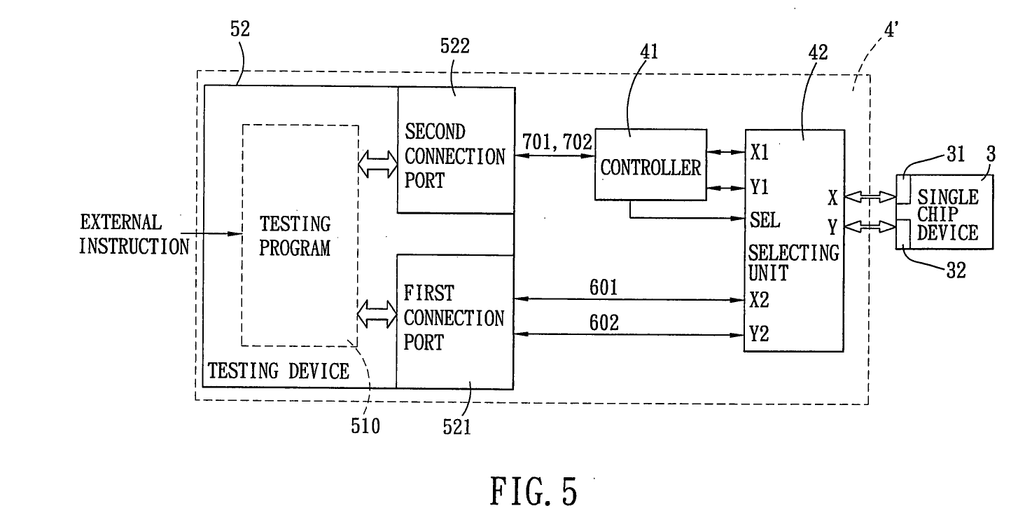

Referring to FIG. 5, the second preferred embodiment of a testing system 4′ for testing the single chip device 3, such as an image sensing device for an optical mouse, according to the present invention is shown to include a testing device 52, a controller 41, and a selecting unit 42.

The testing device 52 includes a first connecting port 521, which has the same configuration as the first connecting port 71 in the first preferred embodiment, adapted to be connected to the first transmission interface 31 of the single chip device 3, and a second connecting port 522, which has the same configuration as the second connecting port 72 in the first preferred embodiment, adapted to connected to the second transmission interface 32 of the single chip device 3. Furthermore, the testing device 52 has a built-in testing program 510.

The controller 41 is coupled to the testing device 52 via the second connecting port 522, and is controlled by the testing device 52.

The selecting unit 42 is coupled to the controller 41, and is adapted to be coupled to the single chip device 3. In this embodiment, the selecting unit 42 is further coupled to the testing device 52 via the first connecting port 521.

The controller 41 is controlled by the testing device 52 through execution of the testing program 510 and based on an external instruction to control the selecting unit 42 so as to enable the single chip device 3 to operate in a desired one of a normal operating mode, where data transmission between the testing device 52 and the single chip device 3 is performed at a first transmission rate via the first connecting port 521, the selecting unit 42 and the first transmission interface 31, and a testing mode, where data transmission between the testing device 52 and the single chip device 3 is performed at a second transmission rate greater than the first transmission rate as described above via the second connecting port 522, the controller 41, the selecting unit 42 and the second transmission interface 32.

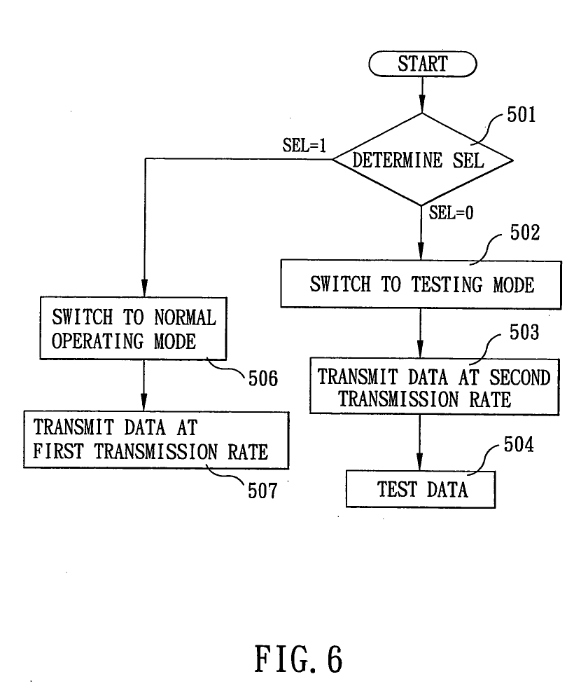

FIG. 6 illustrates an operation procedure of the second preferred embodiment. In step 501, the selecting unit 42 determines whether a logic level on a terminal (SEL) is at “0” or “1” in accordance with a control signal received from the controller 41 in response to control by the testing device 52. In step 502, when the logic level on the terminal (SEL) is at “0”, the selecting unit 42 enables the single chip device 3 to switch to the testing mode in a known manner. In step 503, data transmission is performed at the second transmission rate via the second connecting port 522, the controller 41, the selecting unit 42 and the second transmission interface 32. In step 504, data transmitted from the single chip device 3 is tested by the testing device 52 in a known manner. In step 506, when the logic level on the terminal (SEL) is at “1”, the selecting unit 42 enables the single chip device 3 to switch to the normal operating mode in a known manner. In step 507, data transmission is performed at the first transmission rate via the first connecting port 521, the selecting unit 42 and the first transmission interface 31.

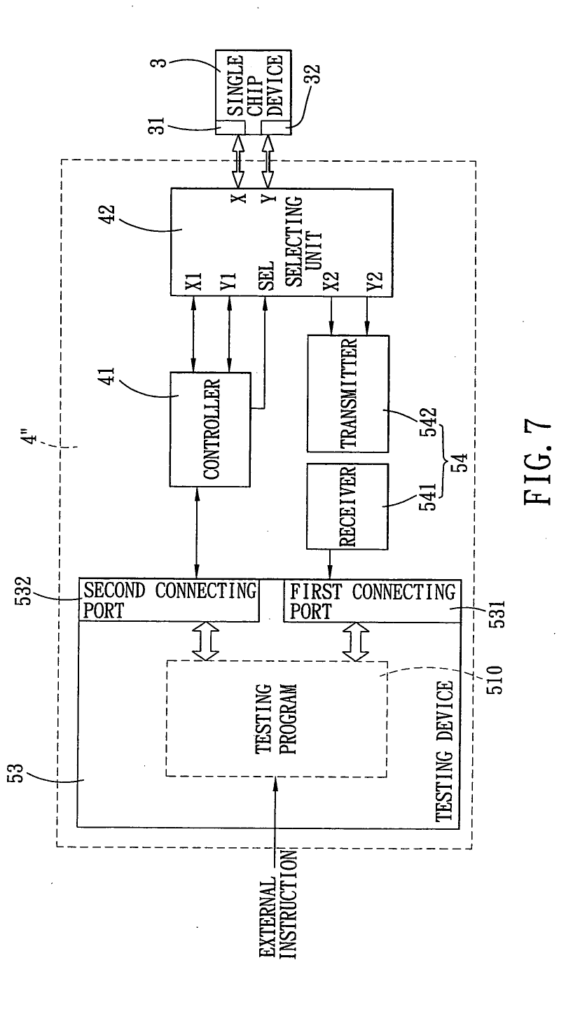

FIG. 7 illustrates the third preferred embodiment of a testing system 4″ for testing the single chip device 3 according to this invention, which is a modification of the second preferred embodiment. Unlike the second preferred embodiment, the first connecting port 531 of the testing device 53 is configured for data transmission in accordance with a wireless communications protocol. In this embodiment, the testing system 4″ further includes an RF transacting module 54 interconnecting the first connecting port 531 and the selecting unit 42. The transacting module 54 includes a transmitter 542 coupled to the selecting unit 42, and a receiver 541 coupled to the first connecting port 531.

It is noted that, when the testing systems 4′, 4″ of the second and third embodiments are applied to a computer device, data transmission in the testing mode conforms with a computer peripheral communications protocol, such as USB, IEEE1394, PCMCIA, PCI, LAN, or print port communications protocol.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A single chip device comprising:
a first transmission interface adapted to be connected to an external testing device;
a second transmission interface adapted to be connected to the testing device; and
a processor unit coupled to said first and second transmission interfaces and operable in one of a normal operating mode, where data transmission between said single chip device and the testing device is performed at a first transmission rate via said first transmission interface, and a testing mode, where data transmission between said single chip device and the testing device is performed at a second transmission rate different from the first transmission rate via said second transmission interface.

2. The single chip device as claimed in claim 1, wherein the second transmission rate is greater than the first transmission rate.

3. The single chip device as claimed in claim 1, further comprising an image sensor coupled electrically to said processor unit and operable so as to generate test data to be transmitted to the testing device.

4. The single chip device as claimed in claim 3, wherein said image sensor is a CMOS device.

5. The single chip device as claimed in claim 3, further comprising an analog-to-digital converter coupled to said image sensor and said processor unit for converting the test data to digital data.

6. The single chip device as claimed in claim 5, further comprising a register coupled electrically to said processor unit.

7. A testing system for testing a single chip device, comprising:
a testing device including first and second connecting ports adapted to be connected to the single chip device, said testing device being adapted to enable the single chip device to operate in a desired one of a normal operating mode, where data transmission is performed at a first transmission rate via said first connecting port, and a testing mode, where data transmission is performed at a second transmission rate via said second connecting port, said first and second connecting ports being configured to transmit data at different transmission rates.

8. The testing system as claimed in claim 7, wherein the second transmission rate is greater than the first transmission rate.

9. The testing system as claimed in claim 7, wherein data transmission in the testing mode conforms with a serial interface communications protocol.

10. The testing system as claimed in claim 9, wherein the serial interface transmission protocol is one of an RS232, I²C and SPI™ communications protocol.

11. The testing system as claimed in claim 7, further comprising:
a controller coupled to and controlled by said testing device; and
a selecting unit coupled to said controller and adapted to be coupled to the single chip device,
said controller being controlled by said testing device to switch said selecting unit so as to enable the single chip device to operate in the desired one of the normal operating mode and the testing mode.

12. The testing system as claimed in claim 7, wherein said first connecting port is configured for data transmission in accordance with a wireless communications protocol.

13. A method for enabling implementation of speedy testing of a single chip device that is coupled to a testing device and that is operable in a normal operating mode, where data transmission is performed at a first transmission rate, said method comprising the steps of:
a) configuring the single chip device to be further operable in a testing mode, where data transmission from the single chip device to the testing device is performed at a second transmission rate different from the first transmission rate;
b) enabling the single chip device to operate in the testing mode; and
c) testing data transmitted from the single chip device at the second transmission rate.

14. The method as claimed in claim 13, wherein the second transmission rate is greater than the first transmission rate.

15. The method as claimed in claim 13, further comprising the step of:
d) enabling the single chip device to operate in the normal operating mode after step c).

16. A single chip device comprising:
an image sensor for generating raw image data;
a processing unit coupled to said image sensor to process the raw image data; and
a transmission interface unit coupled to said processing unit;
said transmission interface unit being operable so as to selectively transmit image data processed by said processing unit by a first transmission protocol, and either of the raw image data or the image data by a second transmission protocol at a transmission rate different from that of the first transmission protocol to an external testing device.

17. A method of testing a single chip device that includes a data acquisition module, a processing unit coupled to the data acquisition module, and a transmission interface unit coupled to the processing unit, said method comprising the steps of:
enabling the data acquisition module to generate raw data;
enabling the processing unit to process the raw data; and
selectively transmitting data processed by the processing unit by a first transmission protocol, and either of the raw data or the data by a second transmission protocol at a transmission rate different from that of the first transmission protocol via the transmission interface unit to an external testing device.
